(19) United States
(12) Patent Application Publication
(10) Pub. No.: US 2022/0168671 A1
(43) Pub. Date: Jun. 2, 2022

(54) LIQUID FILTER

(71) Applicant: Mahle International GmbH, Stuttgart (DE)

(72) Inventor: Michael Braunheim, Goeppingen (DE)

(21) Appl. No.: 17/436,588

(22) PCT Filed: Feb. 14, 2020
(86) PCT No.: PCT/EP2020/053888

§ 371 Date: Sep. 3, 2021

(30) Foreign Application Priority Data
Mar. 4, 2019 (DE) 10 2019 105 414.1

(51) Int. Cl. B01D 29/15; B01D 35/153

(52) U.S. Cl. CPC B01D 29/15; B01D 35/153; B01D 2201/48; B01D 2201/302; B01D 2201/206

(57) ABSTRACT

A liquid filter for a motor vehicle may include a hollow cylindrical housing bowl, a cover that closes the housing bowl, a suspended, hollow cylindrical particle filter arranged in the housing bowl, a catch basin that is opened towards the cover, and an edge overflow. The particle filter may extend parallel to a longitudinal center axis of the housing bowl and may divide the housing bowl into a clean liquid chamber and into a raw liquid chamber. The raw liquid chamber may be fluidically connected to at least one inlet arranged in the cover and the clean liquid chamber to at least one outlet arranged in the cover.

### CROSS-REFERENCE TO RELATED APPLICATIONS

This application claims priority to International Patent Application No. PCT/EP2020/053888 filed Feb. 14, 2020, which in turn claims priority to German Patent Application DE 10 2019 105 414.1 filed Mar. 4, 2019; each of these applications is hereby incorporated by reference in its entirety.

### TECHNICAL FIELD

The invention relates to a liquid filter, in particular a fuel filter for a motor vehicle, according to the preamble of Claim 1.

A suspended fuel filter usually comprises a housing bowl and a firmly installed cover. In the housing bowl, a hollow cylindrical particle filter is arranged and in the cover at least one inlet and at least one outlet are provided. For the intended purpose, the particle filter divides the housing bowl into a raw liquid chamber with the at least one inlet and into a clean liquid chamber with the at least one outlet. The particle filter is a disposable part and has to be regularly changed. To this end, the housing bowl is unscrewed from the cover, the particle filter changed and the housing bowl again screwed to the cover. Also known are fuel filters in which the housing bowl is also changed with the particle filter. Usually, the fuel filter is completely filled with fuel. During the unscrewing of the housing bowl, the fuel therefore runs out of the cover into the housing bowl and then overflows above its upper edge. The edge overflowing fuel hast to be collected or cleaned. Since, when unscrewing the cover, the volume between the housing bowl and the cover increases in size, the fuel is sucked in from the inlet pending the undoing of the cover seal. By way of this, a large quantity of the fuel can be additionally sucked into the liquid filter. It can therefore be practical to first empty the housing bowl, the cover and inlet and outlet lines prior to changing the particle filter. For this purpose, valves on the outlet and on the inlet are closed and fuel is drained out of the fuel filter via a drain screw at the bottom of the housing bowl. Since the drain screw is not easily accessible with every fuel filter, the changing of the particle filter can be rendered difficult. When fuel has not been drained correctly or not at all, the housing bowl during the removal is overfilled with fuel from the cover and from the inlet and outlet lines and the fuel overflows.

This can result in contaminations that have to be cleaned.

### SUMMARY

The object of the invention therefore is to state for a liquid filter of the generic type an improved or at least alternative embodiment, with which the described disadvantages are overcome.

According to the invention, this object is solved through the subject of the independent Claim 1. Advantageous embodiments are subject of the dependent claims.

A generic liquid filter, in particular a fuel filter for a motor vehicle, comprises a hollow cylindrical housing bowl and a cover closing the housing bowl from the top. In the housing bowl, a suspended and hollow cylindrical particle filter is arranged. The particle filter extends parallel to the longitudinal centre axis of the housing bowl and divides the housing bowl into a clean liquid chamber enclosing the longitudinal centre axis and into a raw liquid chamber surrounding the clean liquid chamber. The raw liquid chamber is fluidically connected to at least one inlet arranged in the cover and the clean liquid chamber to at least one outlet arranged in the cover. According to the invention, the liquid filter comprises a catch basin that is open towards the cover and an edge overflow that liquidly connects the raw liquid chamber and the catch basin. With the housing bowl mounted, the inflowing liquid can then flow into the catch basin and over the edge overflow out of the catch basin into the raw liquid chamber and with removed housing bowl the liquid can remain in the catch basin. Here, the catch basin is fixed to or moulded out of the cover and protrudes into the housing bowl at least in regions. By way of this, the catch basin fills out a volume in the housing bowl.

With mounted housing bowl, the catch basin protrudes into the housing bowl so that a part of the liquid is displaced out of the housing bowl and can be received in the catch basin. In other words, a part of the liquid within the housing bowl is situated in the catch basin. From the inlet, the liquid can then flow into the catch basin and over the edge overflow into the raw liquid chamber. When the housing bowl is removed for changing the particle filter, the catch basin remains on the cover and continues to be filled with the liquid. The volume taken up by the catch basin in the housing bowl becomes vacant and can be filled with the remaining liquid from inlet and outlet lines. For the intended purpose, the displaced volume is so large that the remaining liquid can be completely accommodated. Because of the catch basin, the displaced volume can become very large with minimal material usage. By way of the solution according to the invention, the liquid, when changing the particle filter, need not be drained before removing the housing bowl which significantly simplifies the changing of the particle filter. Furthermore, the remaining liquid can be completely collected in the housing bowl and in the catch basin so that contaminations are avoided and a clean changing of the particle filter is possible. The liquid accommodated in the catch basin remains in the liquid filter even after the changing of the particle filter so that the quantity of the liquid to be disposed of can be reduced.

Air, in the liquid filters—and in particular in fuel filters on the pressure side—is undesirable. In particular, the air within the fuel filter leads to longer start-up times of the engine since during the engine start-up the air has to be first compressed by the inflowing fuel and the engine can only run up thereafter. When switching off the engine, the air again expands and pushes the fuel out of the fuel filter. For this reason, a vent is usually provided in the fuel filters, which allows the air to escape from the raw liquid chamber. When the liquid filter according to the invention is used as a pressure-side fuel filter, further advantages materialise. In particular during the inflow of the liquid into the liquid filter according to the invention the catch basin is first filled with the liquid. In the process, the air present in the catch basin is displaced into the raw liquid chamber which during the normal operation is situated below the catch basin. Thus—differing from the conventionally known pressure-side fuel filters—the regions of the liquid filter situated above the raw liquid chamber are vented. The vented regions of the liquid filter above the raw liquid chamber can then be utilised for installing further components of the liquid filter or further geometries of the cover.

It is to be understood that the function of the liquid filter described above and further down below relates to an orientation of the assembled liquid filter during normal operation. In the same, the longitudinal axis of the housing bowl is oriented parallel or near parallel to the plumb direction and the cover, with respect to the gravitational force of the earth, is arranged above the housing bowl. The orientation differing from this is present when the liquid filter is oriented obliquely—and thus the longitudinal centre axis of the housing bowl at an angle to the plumb direction differing from 0°. The function of the liquid filter with such orientation is separately discussed in the following. Accordingly, the terms “top” and “bottom” relate to the orientation of the assembled liquid filter during normal operation with respect to the gravitational force of the earth.

In an advantageous further development of the liquid filter it is provided that the inlet, via an inlet connector, leads fluidically into the catch basin below the edge overflow in the manner of a syphon. Consequently, the inlet connector leads into a chamber of the catch basin provided for receiving the liquid and, with the filled catch basin, engages with the liquid. Because of this, with removed housing bowl, no air can enter the inlet connector via the filled catch basin and the liquid cannot flow out via the inlet connector. This is the case for example with the inlet that is connected via the inlet connector to a return line from the engine. The same has no connection to the atmosphere and the outflow of the liquid can thus be prevented. In this advantageous way, the liquid from inlet lines does not flow into the catch basin so that when changing the particle filter the quantity of the liquid to be disposed can be reduced. A penetration depth of the inlet connector into the catch basin can therefore be adapted to differing orientations of the liquid filter when removing the housing bowl. Thus it can happen for example that when removing the housing bowl the catch basin assumes an oblique position and because of this cannot be completely filled. Through the higher penetration depth of the inlet connector into the catch basin, the entry of air into the inlet connector can thus be prevented during the removing/unscrewing of the housing bowl even with such orientations of the liquid fuel filter.

Advantageously it can be provided that in the cover a connecting line that is fluidically connected to a tank is arranged. The connecting line then leads fluidically and in the manner of a syphon via a connecting piece into the catch basin below the edge overflow. Consequently, the connecting piece leads into a chamber of the catch basin provided for receiving the liquid and with filled catch basin engages with the liquid. With removed housing bowl with filled catch basin, the liquid, in particular in the suction-side liquid filter, can therefore flow back to the tank via the connecting piece. Thus, in the case of maintenance, the quantity of the liquid present in the catch basin can be additionally reduced. The return of the liquid from the catch basin into the tank described here is possible with the arrangement of the tank below the liquid filter. The quantity of the liquid returned from the catch basin back into the tank is limited by the penetration depth of the connecting piece into the catch basin. As soon as the air can enter the connecting piece, the return of the liquid to the tank is interrupted. Through the return, the filling height of the catch basin can be reduced which is advantageous in particular in the case of larger quantities of the liquid present in the cover. When the liquid filter is a fuel filter, fuel, because of a usually lower geodetic head of the tank, can be returned into the same. Here, with the housing bowl removed, flows via the connecting line to the tank until the connecting line is vented from the connecting piece.

Advantageously it can be provided that the inlet connector and the connecting piece have a penetration depth into the catch basin differing from one another, i.e. a different distance to the bottom. In particular, the penetration depth of the connecting piece is smaller than the penetration depth of the inlet connector. Because of this, the inlet connector can engage with the liquid even after a completed return of the liquid from the catch basin into the tank and the entry of air into the inlet connector prevented. Because of this, the remaining liquid from the inlet connector cannot flow into the catch basin. In other words, a residual quantity of the liquid remains in the catch basin even after the liquid from the catch basin has been returned via the connecting line into the tank. This residual quantity is thus sufficient for the inlet connector leading into the catch basin in the manner of a syphon so that the entry of air into the inlet connector is prevented and consequently no liquid can flow via the inlet connector into the catch basin. Here, the inlet connector and the inlet are in particular a return line from the engine in the case of which a draining into the catch basin with removed housing bowl is to be prevented through the syphon-like leading into the liquid.

In an advantageous further development of the liquid filter it is provided that in the cover a second inlet is arranged, which via a second inlet connector leads fluidically into the catch basin below the edge overflow in the manner of a syphon. The second inlet connector consequently leads into a chamber of the catch basin provided for receiving the liquid and, with filled catch basin, engages with the liquid. Because of this, no air can enter the second inlet connector with removed housing bowl with filled catch basin and the liquid cannot flow out via the second inlet connector into the catch basin. Here it can be provided that the inlet connector and the second inlet connector both have a same penetration depth into the catch basin.

Advantageously, the catch basin can be divided into multiple part catch chambers through a separating wall each. Here, the respective separating wall extends axially from a bottom of the catch basin facing the particle filter to the cover. The respective separating wall can extend towards the cover over the edge overflow of the catch basin so that the neighbouring part catch chambers are fluidically separated from one another within the catch basin. Alternatively, the respective separating wall cannot extend towards the cover over the edge overflow of the catch basin so that the neighbouring part catch chambers are fluidically connected to one another within the catch basin. When the liquid filter comprises the at least one inlet connector and/or the second inlet connector and/or the connecting piece, these can lead into the same part catch chamber or into different part catch chambers.

When the liquid filter and because of this the catch basin for example arranged obliquely, the catch basin cannot be completely filled and the liquid can flow out into the housing bowl via the edge overflow of the catch basin. Through the multiple part catch chambers an adequate quantity of liquid can be retained in the catch basin even with such orientations of the liquid filter.

Advantageously it can be provided that the catch basin comprises a bottom that is oriented transversely to the longitudinal centre axis of the housing bowl and a circumferential axial sidewall with a circumferential side edge facing the cover. The edge overflow can be formed by the side edge of the catch basin so that the inflowing liquid can edge-overflow from the catch basin into the raw liquid chamber via the side edge. When the side edge circumferentially protrudes evenly from the bottom, the same is situated in a plane that is oriented transversely to the longitudinal centre axis of the housing bowl. Then, the catch basin can be filled up to the side edge and the penetration depth then indicates also the height of the liquid above the inlet connector and above the second inlet connector or above the connecting piece. Alternatively or additionally, the edge overflow can be formed via a dome edge of at least one overflow dome of the catch basin. Then, the overflow dome is formed within the catch basin and can be additionally tied to the side edge. The liquid inflowing into the catch basin can then edge overflow via the dome edge out of the catch basin into the raw liquid chamber. The dome edge can circumferentially protrude from the bottom evenly and because of this lie in a plane that is oriented transversely to the longitudinal centre axis of the housing bowl. The catch basin can then be filled up to the dome edge and the penetration depth then indicates also the height of the liquid above the inlet connector or above the second inlet connector or above the connecting piece.

Advantageously, a receiving region can be moulded into the catch basin which, sealing circumferentially, receives an outlet connector connecting the outlet and the clean liquid chamber. Then, the catch basin is annular in shape and surrounds the outlet connector. Furthermore, the receiving region and thus the catch basin can be formed integrally with a function carrier of the liquid filter. Advantageously, at least one passage bore can be moulded in the catch basin, wherein a bore wall of the at least one passage bore extends up to the edge overflow of the catch basin or over the edge overflow of the catch basin. The respective passage bore can then receive a screw with which the catch basin is fixed to the cover.

In an advantageous further development of the liquid filter it is provided that the outlet is fluidically connected to the clean liquid chamber via an outlet connector with an annular space and with an edge overflow channel. Here, the outlet leads fluidically into the annular chamber of the outlet connector in the manner of a syphon and is fluidically connected to the clean liquid chamber via the edge overflow channel. By way of the outlet connector configured in such a manner, no air can enter the outlet with the housing bowl removed and because of this the liquid cannot flow out into the clean liquid chamber. In this advantageous way, the remaining liquid from outlet lines does not flow into the housing bowl so that when changing the particle filter the quantity of the liquid to be disposed of can be reduced.

Further important features and advantages of the invention are obtained from the sub-claims, from the drawings and from the associated figure description by way of the drawings.

It is to be understood that the features mentioned above and still to be explained in the following cannot only be used in the respective combination stated, but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION TO THE DRAWINGS

It shows, in each case schematically.

FIG. 1 A part view of a liquid filter according to the invention in section;

FIG. 2 to 6 Sectional views of catch basins of different configurations in the liquid filter according to the invention.

### DETAILED DESCRIPTION

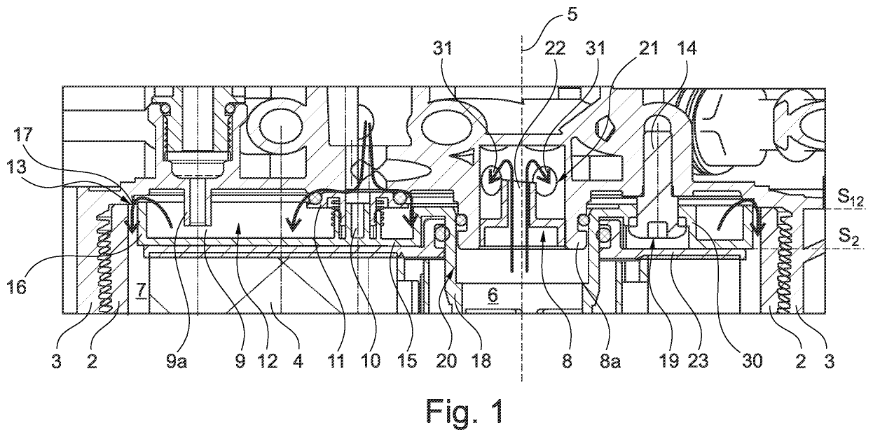

FIG. 1 shows a part view of a liquid filter 1 according to the invention—here a fuel filter—in section. The liquid filter 1 comprises a hollow cylindrical housing bowl 2 and a cover 3 which closes the housing bowl 2 from the top. In this exemplary embodiment, the housing bowl 2 and the cover 3 are screwed together. In the housing bowl 2, a suspended and hollow cylindrical particle filter 4 is arranged, which extends parallel to the longitudinal centre axis 5 of the housing bowl 2. The particle filter 4 divides the housing bowl 2 into a clean liquid chamber 6 and into a raw liquid chamber 7, wherein the clean liquid chamber 6 is fluidically connected to an outlet 8 and the raw liquid chamber 7 to an inlet 9 and to an inlet 10. The outlet 8 and the inlets 9 and 10 are moulded out of the cover 3. Here, the inlet 9 is fluidically connected to a return line which leads from an engine. By way of the return line, the liquid—here fuel—can flow from the engine back into the liquid filter 1. The inlet 10 is fluidically connected to a tank so that the liquid—here fuel—can flow out of the tank into the liquid filter 1 and be filtered. In this exemplary embodiment, a non-return valve 11 is arranged in the inlet 10 which prevents the liquid flowing out of the liquid filter 1 back into the tank.

The liquid filter 1 comprises a catch basin 12 that is open towards the cover 3, which is fluidically connected to the raw liquid chamber 7 via an edge overflow 13. The catch basin 12 is fastened to the cover 3 by screws 14—only one visible here. For this purpose, the catch basin comprises passage bores 19—only one visible here—each with a bore wall 30. The catch basin 12 comprises a bottom 15 oriented transversely to the longitudinal centre axis 5 and a sidewall 16 with a side edge 17. With mounted housing bowl 2—as shown here—the liquid level S₁₂ of the catch basin 12 is situated at the side edge 17. The bottom 15 directly adjoins an end disc 23 of the particle filter 4. In this exemplary embodiment, the catch basin 12 is embodied integrally with a function carrier 18 which engages with the clean liquid chamber 6. Here, the edge overflow 13 is formed by the side edge 17. The catch basin 12 protrudes into the housing bowl 2 in regions and displaces the liquid out of the housing bowl 2, so that the liquid level S₂ of the housing bowl 2 is situated below the liquid level S₁₂ of the catch basin 12. When the housing bowl 2 is removed from the cover 3, the catch basin 12 remains on the cover 3 and a volume taken up by the catch basin 12 is vacated in the removed housing bowl 2.

The inlet 10 leads into the catch basin 12 via the non-return valve 11 and then via the edge overflow 13—in this exemplary embodiment via the side edge 17—further into the raw liquid chamber 7 as is indicated by arrows. Here, a return flow of the liquid out of the liquid filter 1 back into the tank can be prevented by way of the non-return valve 11. The inlet 9 leads into the catch basin 12 via an inlet connector 9a below the circumferential side edge 17 in the manner of a syphon. When the housing bowl 2 is separated from the cover 3 the liquid remains standing in the catch basin 12 and no air can enter the inlet connector 9a. Thus, the remaining liquid from the inlet connector 9a and from the return line connected to the same cannot flow into the catch basin 12. The outlet 8 leads into the clean liquid chamber 6 via an outlet connector 8a, which is sealingly received in a receiving region 20 of the catch basin 12. The receiving region 20 merges into the function carrier 18. The outlet connector 8a comprises an annular chamber 21 and an edge overflow channel 22, wherein outlet openings 31 of the outlet 8 lead into the annular chamber 21 in the manner of a syphon. Then, the liquid flows first over the edge overflow channel 22 into the annular chamber 21 and following this to the outlet openings 31 of the outlet 8, as is indicated by arrows. When the housing bowl 2 is removed from the cover 3 the liquid remains standing in the annular chamber 21 and no liquid can flow out of the outlet openings 31 of the outlet 8 back into the edge overflow channel 22 and further into the housing bowl 2.

Through the advantageous configuration of the liquid filter 1 an edge overflowing of the housing bowl 2 can be advantageously prevented. Furthermore, when changing the particle filter 4, the liquid need not be drained from the housing bowl 2. Altogether, a cleaner and simpler service is possible because of this. Liquid filters of this type are usually vented in the direction of the outlet 8. When filling the catch basin 12 with the liquid, the air situated above the liquid level S₂ is displaced into the raw liquid chamber 7. Then, the displaced air flows below the end disc 23 into the clean liquid chamber 6 and further to the outlet 8. Consequently, regions above the end disc 23 are vented by way of the catch basin 12. These regions can then be utilised for installing components such as for example the non-return valve 11 or the screws 14 or for geometries of the cover 3.

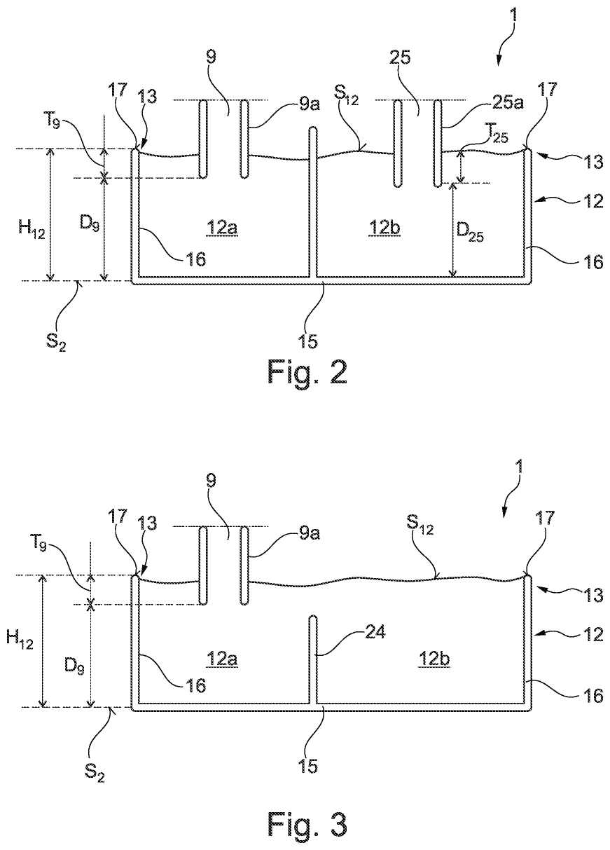

FIG. 2 shows a purely schematic sectional view of a catch basin 12 in the liquid filter 1 that is configured differently from FIG. 1. There, the catch basin 12 is divided by a separating wall 24 into two part catch chambers 12a and 12b. The separating wall 24 extends from the bottom 15 towards the cover 3. In this exemplary embodiment, the separating wall 24 extends over the side edge 17 of the catch basin 12, so that the part catch chambers 12a and 12b within the catch basin 12 are fluidically separated from one another. The inlet 9 leads into the part catch chamber 12a via the inlet connector 9a in the manner of a syphon and a second inlet 25 leads into the part catch chamber 12b via a second connector 25a in the manner of a syphon. The second inlet 25 can be for example a further return line from the engine. The inlet connector 9a has the penetration depth T₉ into the catch basin 12 and the distance D₉ to the bottom 15. Accordingly, the second inlet connector 25a has the penetration depth T₂₅ into the catch basin 12 and the distance D₂₅ to the bottom 15. The respective penetration depths T₉ and T₂₅ and the respective distances D₉ and D₂₅ each add up to the height of the catch basin H₁₂.

FIG. 3 shows a purely schematic sectional view of a catch basin 12 in the liquid filter 1 that is configured differently from FIG. 1 and FIG. 2. Here, the separating wall 24 does not extend over the side edge 17 of the catch basin 12 so that the part catch chambers 12a and 12b within the catch basin 12 are fluidically connected. When the liquid flows into the catch basin 12, the part catch chamber 12a is filled first and then the part catch chamber 12b. By way of the part catch chambers 12a and 12b, the liquid can be retained in an adequate quantity in the catch basin 12 even with oblique positions. The liquid flowing out of the catch basin 12 via its side edge 17 even with oblique positions can be collected in the vacant volume of the housing bowl 2 so that an edge-overflowing of the housing bowl 2 is securely prevented.

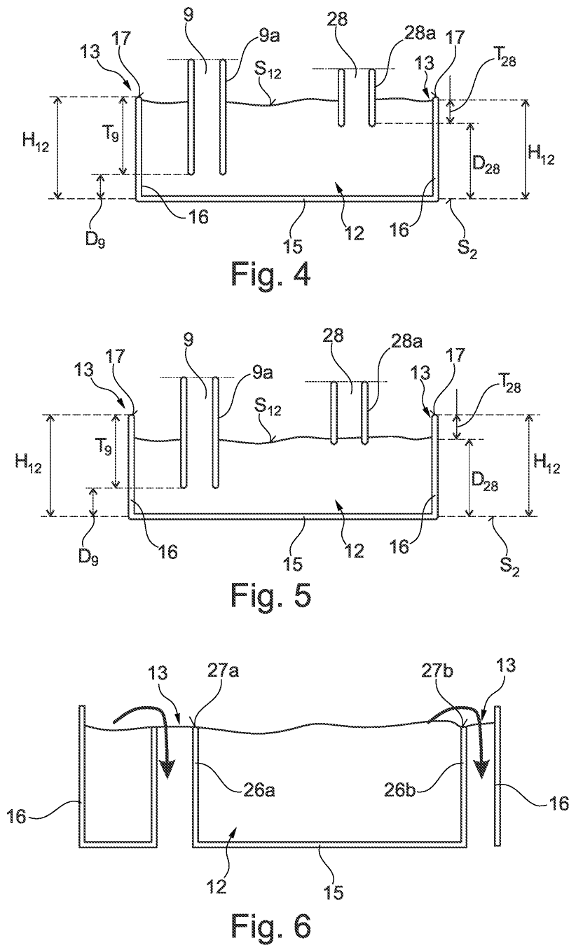

FIGS. 4 and 5 show purely schematic sectional views of a catch basin 12 in the liquid filter 1 configured differently from FIG. 1 to FIG. 3. There, the inlet 9 leads via the inlet connector 9a and a connecting line 28 via a connecting piece 28a into the catch basin 12 in the manner of a syphon. The connecting line 28 fluidically connects the liquid filter 1 to a tank and does not comprise a non-return valve. According to FIG. 4, the housing bowl 2 is not removed and the catch basin 12 is filled with the liquid up to its side edge 17. With removed housing bowl 2, the liquid can flow via the connecting piece 28a to the tank until air can enter the connecting piece 28a. Then, the return of the liquid into the tank is interrupted as shown in FIG. 5. The return of the liquid from the catch basin 12 into the tank is possible because of a lower geodetic head of the tank. The quantity of the liquid returned into the tank is defined by the penetration depth T₂₈ of the connecting piece 28a in the catch basin 12. For the intended purpose, the penetration depth T₉ of the inlet connector 9a is greater than the penetration depth T₂₈ of the connecting piece 28a. Because of this, the inlet connector 9a leads into the catch basin 12 below the lowered liquid level S₁₂ even after the completed return of the liquid into the tank, as shown in FIG. 5. The penetration depth T₉ correlates to the distance of the inlet connector 9a to the bottom 15 and the penetration depth T₂₈ accordingly correlates to the distance D₂₈ of the connecting piece 28a to the bottom 15. The respective penetration depths T₉ and T₂₈ and the respective distances D₉ and D₂₈ each add up to the height H₁₂ of the sidewall 16 of the catch basin 12.

FIG. 6 shows a purely schematic sectional view of a catch basin 12 in the liquid filter 1 configured differently from FIG. 1 to FIG. 5. Here, two overflow domes 26a and 26b are formed within the catch basin 12, each of which have a dome edge 27a and 27b. The dome edge 27a and 27b is situated below the side edge 17 of the catch basin so that the edge overflow 13 on the overflow domes 26a and 26b is exclusively formed by the dome edge 27a and 27b. Here, the overflow dome 26b follows the sidewall 16 of the catch basin 12 and is formed via the same in regions. Since the side edge 17 is situated higher than the dome edge 27b, the liquid on the overflow dome 26b flows over the dome edge 27b and not the side edge 16.

1. A liquid filter for a motor vehicle, comprising:
a hollow cylindrical housing bowl and a cover closing the housing bowl from the top;
a suspended, hollow cylindrical particle filter arranged in the housing bowl, the particle filter extends parallel to a longitudinal center axis of the housing bowl and divides the housing bowl into a clean liquid chamber enclosing the longitudinal center axis and into a raw liquid chamber circulating about the clean liquid chamber (6), and
the raw liquid chamber is fluidically connected to at least one inlet arranged in the cover and the clean liquid chamber to at least one outlet arranged in the cover; and
a catch basin opened towards the cover and an edge overflow fluidically connecting the catch basin and the raw liquid chamber, so that with the housing bowl mounted, an inflowing liquid can flow into the catch basin and over the edge overflow out of the catch basin into the raw liquid chamber and with the housing bowl removed, the liquid can remain in the catch basin, and
wherein the catch basin is fixed to or moulded out of the cover and protrudes into the housing bowl at least in regions, so that the catch basin fills out a volume in the housing bowl.

2. The liquid filter according to claim 1, wherein
the catch basin comprises a bottom oriented transversely to the longitudinal center axis and an axial sidewall with a circumferential side edge facing the cover.

3. The liquid filter according to claim 2, wherein
the edge overflow is formed by the side edge, so that the inflowing liquid can overflow over the side edge out of the catch basin into the raw liquid chamber, and/or
the edge overflow is formed by way of a dome edge of at least one overflow dome of the catch basin, wherein the at least one overflow dome is formed within the catch basin or tied to the side edge within the catch basin, so that the inflowing liquid can overflow over the dome edge out of the catch basin into the raw liquid chamber.

4. The liquid filter according to claim 3, wherein
the inlet, via an inlet connector, fluidically leads into the catch basin below the edge overflow in a manner of a syphon, so that with the housing bowl removed, no air can enter the inlet connector via the filled catch basin and because of this the liquid cannot flow out via the inlet connector.

5. The liquid filter according to claim 4, wherein
in the cover, a connecting line that is fluidically connected to a tank is arranged, which via a connecting piece, fluidically leads into the catch basin below the edge overflow in a manner of a syphon, so that with the housing bowl removed, liquid can flow via the filled catch basin via the connecting piece to the tank.

6. The liquid filter according to claim 5, wherein
the inlet connector and the connecting piece each have a penetration depth into the catch basin that differ from one another.

7. The liquid filter according to claim 6, wherein
in the cover, a second inlet is arranged, which fluidically leads via a second inlet connector into the catch basin below the edge overflow in a manner of a syphon, so that with the housing bowl removed, with the filled catch basin no air can enter the second inlet connector and because of this liquid cannot flow out via the second inlet connector.

8. The liquid filter according to claim 7, wherein
the inlet connector and the second inlet connector have a same penetration depth in the catch basin.

9. The liquid filter according to claim 8, wherein
the catch basin is divided into multiple part catch chambers by a separating wall, wherein the respective separating wall axially extends from a bottom of the catch basin facing the particle filter towards the cover.

10. The liquid filter according to claim 9, wherein
the respective separating wall extends towards the cover, above the edge overflow of the catch basin, so that neighbouring part catch chambers within the catch basin are fluidically separated from one another, or
the respective separating wall does not extend towards the cover above the edge overflow of the catch basin so that the neighbouring part catch chambers within the catch basin are fluidically connected to one another.

11. The liquid filter according to claim 10, wherein
in the catch basin a receiving region is formed, which, sealing circumferentially, receives an outlet connector connecting the outlet and the clean liquid chamber.

12. The liquid filter according to claim 11, wherein
the receiving region and thus the catch basin are integrally formed with a function carrier of the liquid filter.

13. The liquid filter according to claim 12, wherein
in the catch basin, at least one passage bore is formed, wherein a bore wall of the at least one passage bore extends up to the edge overflow of the catch basin or above the edge overflow of the catch basin.

14. The liquid filter according to claim 13, wherein
the outlet is fluidically connected to the clean liquid chamber via an outlet connector and to an annular chamber and to an edge overflow channel, wherein the outlet fluidically leads into the annular chamber of the outlet connector in a manner of a syphon and via the edge overflow channel is fluidically connected to the clean liquid chamber.

15. A liquid filter, comprising:
a housing bowl;
a cover enclosing at least a portion of the housing bowl;
a filter arranged in the housing bowl, the filter divides the housing bowl into a clean liquid chamber and a raw liquid chamber;
at least one inlet arranged in the cover and fluidically connected to the raw liquid chamber;
at least one outlet arranged in the cover and fluidically connected to the clean liquid chamber; and
a catch basin fixed to the cover, at least a portion of the catch basin protrudes into the housing bowl.

16. The liquid filter of claim 15, further comprising an edge overflow fluidically connecting the catch basin and the raw liquid chamber.

17. The liquid filter of claim 16, wherein an inflowing liquid flows into the catch basin and over the edge overflow into the raw liquid chamber.

18. The liquid filter of claim 17, wherein the inlet fluidically leads into the catch basin below the edge overflow in a manner of a syphon.

19. The liquid filter of claim 18, wherein in the cover, a connecting line fluidically leads in the catch basin below the edge overflow in a manner of a syphon.

20. The liquid filter of claim 19, wherein in the catch basin, a receiving region is formed, which receives an outlet connector connecting the outlet and the clean liquid chamber.
